(19) United States
(12) Patent Application Publication
(10) Pub. No.: US 2024/0049087 A1
(43) Pub. Date: Feb. 8, 2024

(54) COMMUNICATION DEVICE, COMMUNICATION SYSTEM, COMMUNICATION METHOD, AND NON-TRANSITORY COMPUTER-READABLE MEDIUM

(71) Applicant: NEC Corporation, Minato-ku, Tokyo (JP)

(72) Inventor: Shinichi Anami, Tokyo (JP)

(73) Assignee: NEC Corporation, Minato-ku, Tokyo (JP)

(21) Appl. No.: 18/268,357

(22) PCT Filed: Mar. 25, 2021
(86) PCT No.: PCT/JP2021/012665

§ 371 Date: Jun. 20, 2023

(51) Int. Cl. H04W 36/14; H04W 72/56; H04W 72/54

(52) U.S. Cl. CPC H04W 36/14; H04W 72/56; H04W 72/54

(57) ABSTRACT

A communication device includes: wireless communication interfaces corresponding to wireless communication technologies, respectively; a characteristic acquisition and presentation unit that acquires information indicating wireless communication characteristics related to the communication device including the wireless communication interfaces and presents the information to a user; a set information acquisition unit that acquires information set by the user with respect to the presented information indicating wireless communication characteristics related to the communication device; a rule creation unit that interprets the information indicating wireless communication characteristics and the set information, and creates a selection rule for selecting one wireless communication technology from among the wireless communication technologies; a situation grasping unit that grasps communication qualities according to the wireless communication interfaces; and a selection unit that selects a wireless communication interface corresponding to a wireless communication technology to be prioritized among the wireless communication technologies based on the selection rule and the communication qualities.

### TECHNICAL FIELD

The present disclosure relates to a communication device, a communication system, a communication method, and a program.

### BACKGROUND ART

Automation of conveyance of materials and products has expanded in automated warehouses and between processes at manufacturing sites. Although the automatic conveyance system itself has been conventionally utilized, there is an increasing demand for a system for producing various kinds of products in small quantities, and further, for mechanization of work having a high physical load such as conveyance of heavy goods. In addition, with the development of technology to meet the demand, not only a conventional automatic conveyance system in which a travel route is fixed but also a conveyance system with a high degree of freedom capable of flexibly coping with a layout change or a route change is required.

Compared with this conventional system, recent systems require finer control-related information. The conventional system is operated and managed so as not to block a route of an auto-moving truck, and in some cases, the route is surrounded by a safety fence so that a person or an object other than the system including the auto-moving truck cannot enter the route. In such a system, once a destination is instructed to the auto-moving truck, the auto-moving truck can move toward the destination. If the auto-moving truck receives a next destination after the movement, the auto-moving truck can move to the next destination. That is, if information for instructing a destination can be intermittently transmitted and received to and from the auto-moving truck, the system would be established.

However, in a system with a high degree of freedom that is currently required, there is no fixed route, and an obstacle or a person may appear or cross a travel route. Therefore, current position information of the auto-moving truck and instruction information such as which way to move next and a travel route are required in real time, and accordingly, exchange of detailed information is required between the control device and the auto-moving truck, and the demand for responsiveness is also high. Since the auto-moving truck moves, it is difficult to connect a wired cable for communication thereto, and information is exchanged through wireless communication in most cases.

For such a system, a unique wireless technology may be used, but wireless LAN (IEEE 802.11) communication, which can be realized at low cost without requiring a license, is adopted in most cases. Meanwhile, since the auto-moving truck moves, there has been a problem that disconnection or a great delay occurs due to movement out of an area covering an access point (AP), movement to a shadow of an obstacle, a change in connection to the AP, or the like, and an instruction does not pass onto the auto-moving truck, which stops conveyance. Therefore, each of Patent Literatures 1 to 4 discloses a control method for communication using a route having a good communication quality by checking the respective qualities of communication routes for a plurality of wireless communication units.

### CITATION LIST

### Patent Literature

Patent Literature 1: Published Japanese Translation of PCT International Publication for Patent Application, No. 2006-518973
Patent Literature 2: Japanese Unexamined Patent Application Publication No. 2002-112347
Patent Literature 3: Published Japanese Translation of PCT International Publication for Patent Application, No. 2015-528670
Patent Literature 4: Japanese Unexamined Patent Application Publication No. 2013-207731

### SUMMARY OF INVENTION

### Technical Problem

In Patent Literature 1, a selection criterion for selecting a plurality of wireless access media is stored in a database, and the selection criterion is variable by user. However, Patent Literature 1 describes CDMA2000 and WLAN as examples of wireless access media, and describes that WLAN is used if there is no problem in availability of WLAN. Therefore, the technology described in Patent Literature 1 is valid only in a case where priorities of a plurality of wireless communication means are clear and availability (of CDMA2000) can be ensured.

However, in a system using local 5G and WLAN, which is expected to be introduced and spread in the future, the availability of the wireless communication technology cannot be ensured depending on a situation in which the base station is installed and how the cover area is designed, and priorities of a plurality of wireless communication technologies may change depending on use environments. Therefore, there is a need for a method capable of determining a wireless communication means to be used on the basis of communication requirements and required environmental information rather than priorities of communication means. In addition, in a case where there are a plurality of wireless communication means in the same communication technology such as two WLANs, it is not possible to perform prioritization and operation.

Patent Literature 2 (Japanese Unexamined Patent Application Publication No. 2002-112347) discloses a wireless terminal device capable of automatically switching a wireless communication system connected thereto depending on an application content, a communication state, a user state, a surrounding environmental condition, and the like. Specifically, a communication means with low power consumption is selected while satisfying the necessary communication performance derived from the application or content (transmission of video or mail) and a screen resolution of a terminal. It is preferable that a running application and the performance of each communication means are fixed, but in reality, the performance of the communication unit cannot be ensured due to various factors such as a distance relationship with a base station, a line of sight, and interference with other systems. Therefore, the technology described in Patent Literature 2 is not valid in a system in which a communication unit and a communication performance change from moment to moment. In addition, the technology described in Patent Literature 2 does not have a means for a user to input or change the selection situation.

Patent Literature 3 discloses a wireless communication terminal that selects a wireless access scheme to be used for communication. In addition, Patent Literature 3 describes that a list is displayed on a display on the basis of a display condition set by the user of the wireless communication terminal, and the user inputs the display condition on a setting screen.

Patent Literature 4 discloses a communication terminal device including a plurality of wireless communication devices that perform wireless communication in different wireless communication technologies. In addition, Patent Literature 4 also describes that a wireless communication state in each wireless communication device is detected in real time, and a result thereof is notified according to an instruction of a communication data control unit.

However, in Patent Literatures 3 and 4, a route selection rule is optimized with a combination of a wireless communication technology and a purpose of use assumed in advance. Therefore, it is not possible to optimally select a route in any communication scheme for any purpose of use.

In many cases not limited to the above-mentioned patent literatures, communication means, their characteristics, and priorities of the communication means are limited. However, due to technological development and miniaturization, devices and communication means have been separated and generalized, and the technology according to the related art is not capable of coping with a change in combination of communication means and a change in user or purpose of use.

Therefore, there is a need for a method capable of autonomously selecting any communication unit in consideration of a situation that can occur in combination of a communication means, an environment, a purpose of use, etc. without depending on a communication means included in the device, its characteristics, an installation environment of an opposing device, and a purpose of use.

The present invention has been made to solve such a problem, and an object of the present invention is to provide a communication device, a communication system, a communication method, a program, and the like capable of flexibly coping with various communication technologies and various purposes of us.

### Solution to Problem

According to a first aspect of the present disclosure, there is provided a communication device including:
a plurality of wireless communication interfaces corresponding to a plurality of wireless communication technologies, respectively;
a characteristic acquisition and presentation unit that acquires information indicating wireless communication characteristics related to the communication device including the plurality of wireless communication interfaces and presents the information to a user;
a set information acquisition unit that acquires information set by the user with respect to the presented information indicating wireless communication characteristics related to the communication device;
a rule creation unit that interprets the information indicating wireless communication characteristics and the set information, and creates a selection rule for selecting one wireless communication technology from among the plurality of wireless communication technologies;
a situation grasping unit that grasps communication qualities according to the plurality of wireless communication interfaces; and
a selection unit that selects a wireless communication interface corresponding to a wireless communication technology to be prioritized among the plurality of wireless communication technologies on the basis of the selection rule and the communication qualities.

According to a second aspect of the present disclosure, there is provided a communication system including:
a communication device; and
a mobile body on which the communication device is mounted,
in which the communication device includes:
a plurality of wireless communication interfaces corresponding to a plurality of wireless communication technologies, respectively;
a characteristic acquisition and presentation unit that acquires information indicating wireless communication characteristics related to the communication device including the plurality of wireless communication interfaces and presents the information to a user;
a set information acquisition unit that acquires information set by the user with respect to the presented information indicating wireless communication characteristics related to the communication device;
a rule creation unit that interprets the information indicating wireless communication characteristics and the set information, and creates a selection rule for selecting one wireless communication technology from among the plurality of wireless communication technologies;
a situation grasping unit that grasps communication qualities according to the plurality of wireless communication interfaces; and
a selection unit that selects a wireless communication interface corresponding to a wireless communication technology to be prioritized among the plurality of wireless communication technologies on the basis of the selection rule and the communication qualities.

According to a third aspect of the present disclosure, there is provided a communication method including:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.

According to a fourth aspect of the present disclosure, there is provided a program or a recording medium storing the program, the program causing a computer to execute:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.

### Advantageous Effects of Invention

According to the present disclosure, it is possible to provide a communication device, a communication system, a communication method, a program, and the like capable of flexibly coping with various communication technologies and various purposes of use.

### BRIEF DESCRIPTION OF DRAWINGS

FIG. 1 is a block diagram illustrating a configuration of a communication device according to a first example embodiment.

FIG. 2 is a flowchart for explaining a communication method according to the first example embodiment.

FIG. 3 is a diagram illustrating a configuration of a communication system according to a second example embodiment.

FIG. 4 is a diagram illustrating a configuration of a communication device according to the second example embodiment.

FIG. 5 is a flowchart for explaining a communication method according to the second example embodiment.

FIG. 6 is a block diagram illustrating an example of a hardware configuration of the communication device.

### EXAMPLE EMBODIMENT

### First Example Embodiment

Hereinafter, example embodiments of the present invention will be described with reference to the drawings.

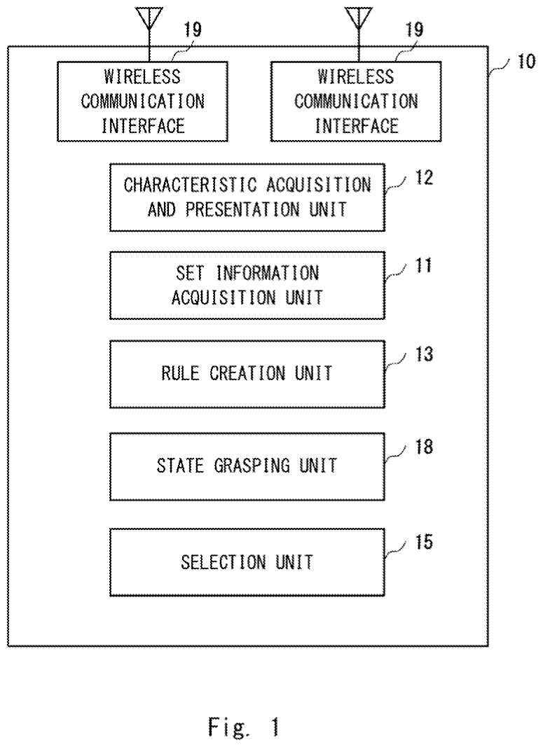

FIG. 1 is a block diagram illustrating a configuration of a communication device according to a first example embodiment.

The communication device 10 can be realized by a computer including a processor, a memory, etc. The communication device 10 includes a plurality of wireless communication interfaces 19 corresponding to a plurality of wireless communication technologies, and a characteristic acquisition and presentation unit 12 that acquires information indicating wireless communication characteristics related to the communication device 10 including the plurality of wireless communication interfaces 19 and presents the information to a user.

The plurality of wireless communication technologies mentioned here may include a plurality of identical wireless communication technologies, or may include a plurality of different wireless communication technologies. The plurality of identical wireless communication technologies may use the same frequency band using the same communication technology, e.g., Wifi. The different wireless communication technologies may be, for example, different communication technologies such as Wifi and long term evolution (LTE), or may use different frequency bands in the same communication technology (e.g., Wifi). The plurality of wireless communication technologies may include wifi and local generation (5G: fifth generation mobile communication system) communication technologies. The plurality of wireless communication technologies may include short-range communication technologies such as Bluetooth (registered trademark), wireless LAN, and home radio frequency (RF). The wireless communication technologies are not limited thereto, and may include any suitable communication technologies. Wireless communication technologies after the sixth generation mobile communication system are also applicable. The information indicating wireless communication characteristics can include not only used frequency bands, wireless communication standards, and wireless communication technologies but also information indicating capabilities of the plurality of wireless communication interfaces of the communication device. Examples of the information indicating the capabilities can include capability of mobile communication, capability of being compatible with a communication standard, capability of roaming, and the like.

The characteristic acquisition and presentation unit 12 may present specific information indicating wireless communication characteristics related to the communication device 10 including the plurality of wireless communication interfaces 19, or may present abstracted information so that the user can easily understand or select the information.

The communication device 10 further includes a set information acquisition unit 11 that acquires information set by the user for the presented information indicating wireless communication characteristics.

The information set by the user can include a purpose of use for which the user wants to use the communication device, a use environment, a performance, etc. In another example embodiment, such set information may be input for each wireless communication technology or for each wireless communication interface as the information set by the user.

The communication device 10 further includes a rule creation unit 13 that interprets the information indicating wireless communication characteristics of the communication device 10 and the acquired information set by the user, and creates a selection rule for selecting one wireless communication technology from among the plurality of wireless communication technologies. The rule creation unit 13 may include a rule description unit that describes a selection rule on the basis of a user input.

The communication device 10 includes a situation grasping unit 18 that grasps communication qualities according to the plurality of wireless communication interfaces 19, and a selection unit 15 that selects a wireless communication interface corresponding to a wireless communication technology to be prioritized among the plurality of wireless communication technologies on the basis of the selection rule and the communication qualities.

The situation grasping unit 18 can individually grasp a communication situation for each of the plurality of wireless communication interfaces 19.

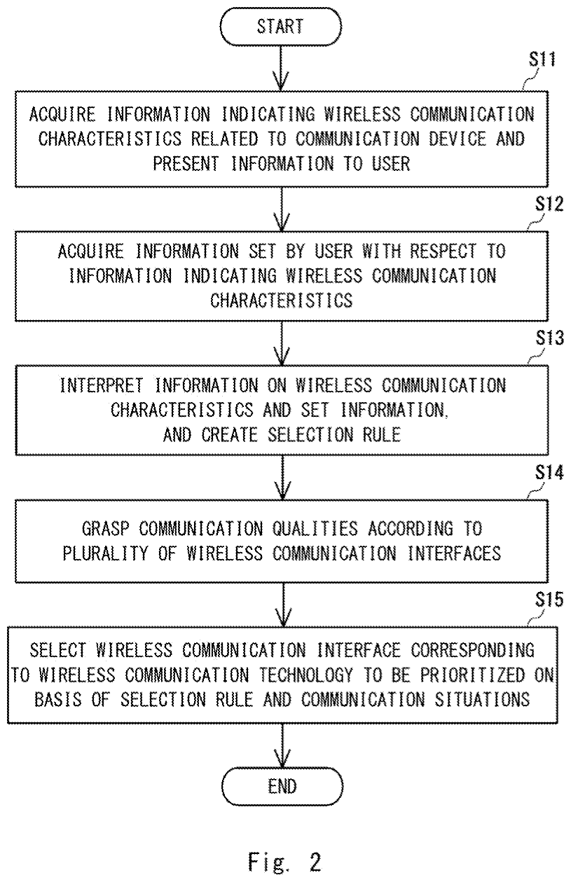

FIG. 2 is a flowchart illustrating a communication method according to the first example embodiment.

The communication method according to the present example embodiment is a communication method using the communication device 10 including the plurality of wireless communication interfaces 19 corresponding to the plurality of wireless communication technologies, respectively.

The characteristic acquisition and presentation unit 12 acquires information indicating wireless communication characteristics related to the communication device 10 including the plurality of wireless communication interfaces 19 and presents the information to the user (step S11). The set information acquisition unit 11 acquires information set by the user for the presented information indicating wireless communication characteristics related to the communication device (step S12). The rule creation unit 13 interprets the information indicating wireless communication characteristics and the set information, and creates a selection rule for selecting one wireless communication technology from among the plurality of wireless communication technologies (step S13). The situation grasping unit 18 grasps communication qualities according to the plurality of wireless communication interfaces 19 (step S14). The selection unit 15 selects a wireless communication interface corresponding to a wireless communication technology to be prioritized among the plurality of wireless communication technologies on the basis of the selection rule and the communication qualities (step S15).

According to the communication device and the communication method according to the first example embodiment described above, it is possible to create a rule for selection from among a plurality of wireless communication technologies in consideration of wireless communication characteristics of the communication device and information set by a user, thereby selecting an optimum wireless communication technology.

### Second Example Embodiment

In a conventional communication device having a plurality of communication units, it is general that the plurality of communication units are a plurality of wireless communication units having the same characteristics including the same communication technology. However, in a case where the number of auto-moving trucks in operation increases or the communication band increases due to advancement of applications, there is a possibility that the wireless LAN, which is currently the most widely used, cannot cope with the increase due to the number of simultaneous connections or frequency resources.

Provision of 5th generation (5G: fifth generation mobile communication system) communication services, in particular, local 5G communication services independently constructed by companies has started, and the companies have started to consider adoption thereof from specifications capable of low delay, large capacity, and multi-device connection. Therefore, the present example embodiment is implemented by using communication technologies having different characteristics, such as an existing wireless LAN environment and a newly introduced local 5G.

As a method of selecting one communication technology from the communication technologies having different characteristics, various methods such as selection of a carrier network and a wireless LAN of a mobile terminal have been disclosed. However, their selection rules are defined according to the communication technologies of the communication devices and purposes of use.

Here, a system capable of selecting a communication interface suitable for the communication technology is realized in consideration of various characteristics such as a wireless communication technology, communication quality thereof, communication requirements, mutual influences with other communication systems, and costs required for use. Note that, since the acquisition of the communication quality for control in selecting one communication technology is a known technique, an example embodiment for considering the various characteristics will be described below.

A communication device having a plurality of communication interfaces having different communication technologies and characteristics acquires communication characteristics and presents the acquired characteristics to a user in an abstracted form that needs to be considered by the user. The acquired characteristics are information indicating specific communication technologies, used frequency bands, etc., but are difficult for the user to understand or select as they are. Therefore, the communication characteristics are presented to the user in the abstracted form.

Examples of the abstracted characteristics that need to be considered include a purpose of use for which a certain amount of data is continuously transmitted, such as a web conference, an IP call, and remote monitoring, a purpose of use for which a certain response performance is required, such as work for a person and control information for a machine, and a purpose of use in a best effort type such as business system input/output and file transfer. By selecting one characteristic from the presented wireless communication characteristics, the user can provide information set by the user to the communication device.

In addition, the communication device acquires, as information set by the user, a communication requirement for an application such as a bandwidth to be used according to the purpose of use or a time for which disconnection is determined. The communication requirement may be, for example, a bandwidth, a responsiveness or disconnection determination time, or the like.

Furthermore, the communication device acquires, as information set by the user, information regarding use environment that needs to be considered in each purpose of use. The information regarding use environment is related to specification environments, e.g., a communication technology and an operation mode of the mounted communication means, a frequency used by the mounted communication means, a location at which used is used such as indoors and outdoors, whether the terminal itself moves, and whether a metal object around the terminal moves.

In addition, the communication device acquires a relationship with another system and information to be stopped in operation as information set by the user. Examples of the relationship with another system and the information to be stopped in operation include a frequency used in another system, a frequency exclusively allocated to the communication system, and a usage fee in a pay-per-use type.

Although these pieces of information are not essential items, the user may be requested to input such information if necessary because many pieces of such information are difficult to acquire from the inside of the communication device.

The communication device describes a selection rule based on the acquired characteristic information and the information set by the user. The communication device sets a priority of a communication technology under various conditions or a selection threshold as the selection rule. The communication device can confirm the described selection rule with the user, and can accept a new setting when correction is necessary. Alternatively, the user may directly describe a selection rule.

A state grasping unit in the communication device passes capability information of each communication unit, communication performance estimated at each time, and the like to the control unit via a software interface in the communication device. The control unit switches the selection rule according to the state, and selects one communication interface from among the plurality of communication interfaces on the basis of the adopted selection rule.

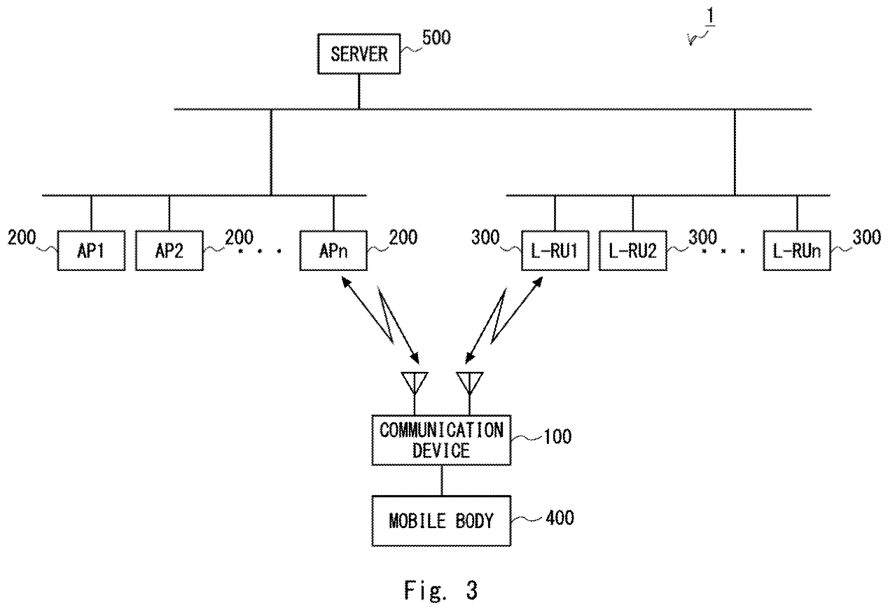

A configuration of a communication system will be described with reference to FIG. 3.

The communication system 1 includes a mobile body 400 (e.g., an auto-moving truck), and a communication device 100 mounted on the mobile body 400 and having a plurality of communication interfaces to execute communication using a communication interface suitable for a high-quality communication technology. The mobile body 400 is connected to the communication device 100 by a wired manner. The mobile body 400 can move in a site upon receiving an instruction such as a destination from a server 500 via wireless communication. A plurality of access points (APs) 200 and a plurality of local-radio units (L-RUs) 300 are provided in the site. The plurality of access points (APs) 200, which are connection destinations to which the communication device 100 is connected by wireless communication, are configured to be connected by a network. The plurality of access points (APs) 200 may be referred to as first base stations herein. The plurality of local-radio units (L-RUs) 300 are connected by a network that is a communication technology different from that for the APs 200. The plurality of local-radio units (L-RUs) 300 may be referred to as second base stations herein.

Note that examples of the mobile body include not only an auto-moving truck but also various moving objects such as a vehicle, a drone, a train, and an airplane. Furthermore, the present disclosure is also applicable even in a case where a person possesses a communication device as an example other than the mobile body.

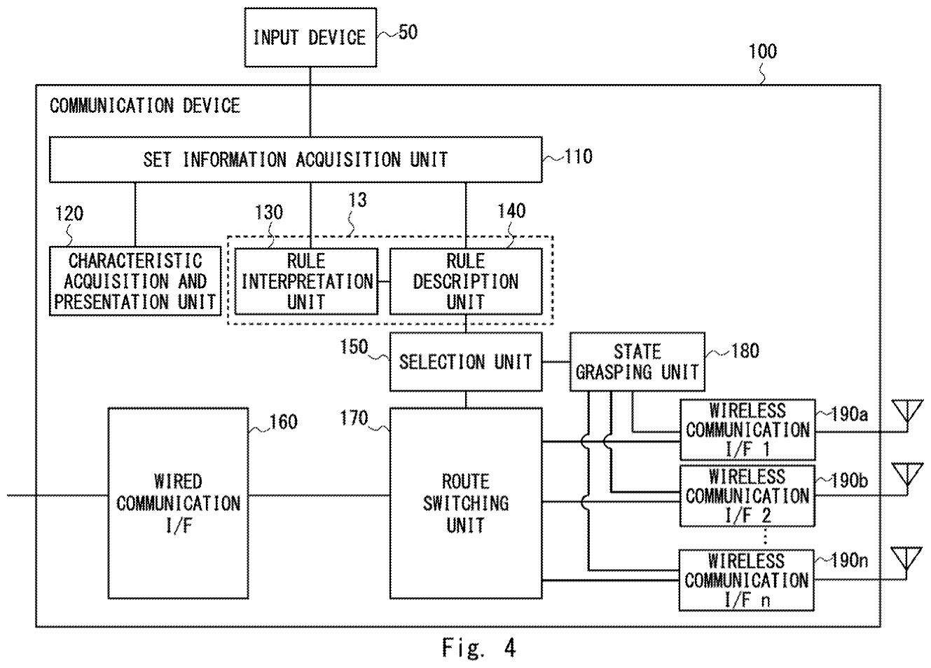

An example of a configuration of a communication device 100 will be described with reference to FIG. 4.

The communication device 100 can include a set information acquisition unit 110, a characteristic acquisition and presentation unit 120, a rule interpretation unit 130, a rule description unit 140, a selection unit 150, a wired communication interface 160, a route switching unit 170, a state grasping unit 180, and a plurality of communication interfaces 190 (190a to 190n).

The characteristic acquisition and presentation unit 120 acquires wireless communication characteristics (e.g., characteristics according to used frequency bands or communication standards/communication technologies) and presents necessary information to the user. The characteristic acquisition and presentation unit 120 may abstract the information into information that can be understood or selected by the user and present the abstracted information to the user. When the user inputs set information via an input device 50 (FIG. 4) such as a keyboard and a mouse, the set information acquisition unit 110 acquires the information set by the user.

The rule interpretation unit 130 interprets the wireless communication characteristics and the information set by the user, and creates a selection rule. The rule description unit 140 presents the interpreted rule to the user and enables the user to correct the description, or the rule description unit 140 enables the user to describe a selection rule from the beginning. The rule interpretation unit 130 and the rule description unit 140 may be collectively referred to as a rule creation unit 13. In some example embodiments, the rule creation unit 13 may include only the rule description unit 140 because the user describes a selection rule from 1. In other example embodiments, the rule creation unit 13 may include only the rule interpretation unit 130.

The rule creation unit 13 can select an optimum rule on the basis of the wireless communication characteristics and the information set by the user.

In addition, the selection unit 150 selects a communication interface suitable for the communication technology on the basis of the selection rule. The wired communication interface 160 executes wired LAN communication with a device outside the communication device. The route switching unit 170 connects the wired communication interface 160 and one wireless communication interface (e.g., the wireless communication interface 190a), and switches the wireless communication interface (e.g., the wireless communication interface 190a) to be connected according to the selection result of the selection unit 150.

The state grasping unit 180 grasps specification information and a quality state of each wireless communication interface. The wireless communication interface 190 is a communication interface for executing wireless communication with another communication device outside the communication device 100. The communication device 100 includes a plurality of wireless communication interfaces corresponding to the plurality of wireless communication technologies, respectively.

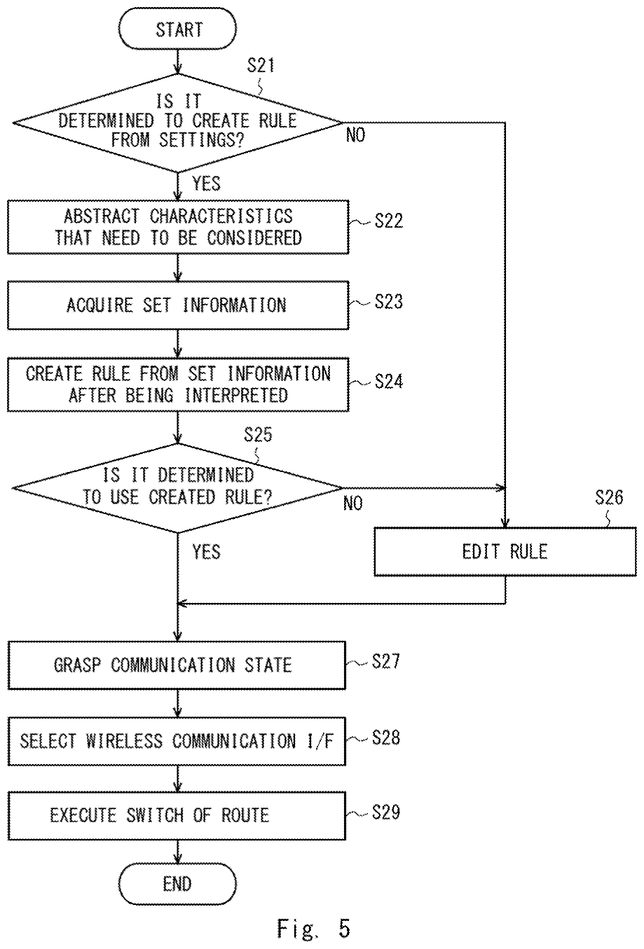

A communication method according to the second example embodiment will be described with reference to FIG. 5.

First, the communication device 100 determines whether to create a rule from settings (step S21). When it is determined to create a selection rule (YES in step S21), the characteristic acquisition and presentation unit 120 acquires wireless communication characteristics related to the communication device, abstracts characteristics that needs to be considered in creating the selection rule, and presents the abstracted characteristics to the user (step S22). That is, the characteristic acquisition and presentation unit 120 requests the user to make settings via the input device 50 and the set information acquisition unit 110. The set information acquisition unit 110 acquires the set information when the user inputs settings via the input device (step S23). The set information can be changed at any timing.

Examples of information regarding communication requirement (purpose of use) among the information set by the user include a purpose of use for which a certain amount of data is continuously transmitted, such as a web conference, an IP call, and remote monitoring, a purpose of use for which a certain response performance is required, such as work for a person and control information for a machine, and a purpose of use in a best effort type such as business system input/output and file transfer. In addition, as an example of additional information (communication performance) regarding the communication requirement, a communication requirement for an application such as a bandwidth to be used according to each purpose of use or a time for which disconnection is determined is acquired. For example, the bandwidth may be 200 kbps, and the responsiveness or disconnection determination time may be 1 sec.

Examples of information regarding communication requirement (use environment) among the information set by the user include information related to specification environments such as communication technologies and operation modes of a plurality of mounted communication interfaces, frequencies used by the plurality of mounted communication interfaces, locations at which the plurality of mounted communication interfaces are used such as indoors and outdoors, whether the terminals themselves move, and whether metal objects around the terminals move.

Furthermore, examples of information regarding priority other than the communication requirement (operation) among the set information include a frequency used by another communication system, a frequency exclusively allocated to the communication system 1, and a cost required for communication (e.g., a communication cost and a pay-per-use system).

Upon acquiring the set information from the user, the set information acquisition unit 110 passes the set information to the rule interpretation unit 130. The rule interpretation unit 130 (or the rule creation unit 13) creates a rule for selection from among the plurality of communication interfaces 190 from the information indicating wireless communication characteristics and the acquired set information (step S24). A plurality of selection rules may be created for each purpose of use or for each communication requirement. At that time, the selection rule can be created to select the most appropriate communication technology from among the communication performances required by the application. For example, in order to realize short-distance local communication, a wireless communication technology such as Bluetooth (registered trademark), a wireless LAN, or home radio frequency (RF) may be selected. A public wireless communication technology such as a personal handy-phone system (PHS) may be selected in order to realize a mobile body such as an auto-moving truck moving at a high speed while performing wireless communication.

Whether to use the rule created by the rule interpretation unit 130 (or the rule creation unit 13) as it is determined via a user input (step S25). When the created rule is used as it is (YES in step S25), the process proceeds to step 27. On the other hand, when the created rule is not used as it is (NO in step S25), the rule description unit 140 corrects the rule via an input from the user (step S26). After the correction, the process proceeds to step 27.

The state grasping unit 180 acquires information regarding communication quality and the like from the communication interfaces 190 and grasps a current wireless communication state in real time (step S27). Examples of the information regarding communication quality and the like include a communication standard, a used frequency, a reception strength (e.g., a received signal strength indicator (RSSI)), a signal-to-noise ratio (SNR), a transmission output, a transmission error rate, a transmission data amount, a transmission cycle, a response time, and the like. In order to grasp the wireless communication state, a new index may be estimated from the information. For example, an available communication band, a delay time, an application, and the like can be estimated in order to grasp the wireless communication state. The state grasping unit 180 passes the wireless communication states to the selection unit 150.

From the wireless communication state information received from the state grasping unit 180, the selection unit 150 determines one rule from among the plurality of selection rules received from the rule interpretation unit 130. Further, the selection unit 150 selects a communication interface suitable for the communication technology on the basis of the rule (step S28). The route switching unit 170 is notified of the selected communication interface.

The route switching unit 170 reconnects the wired communication interface 160 and the wireless communication interface 190 so that the wireless communication interface 190 received from the selection unit 150 is used (step S29).

The communication system according to the second example embodiment described above is capable of realizing a flexible mechanism for high-quality and stable communication in a communication path of the communication device in any combination among various purposes of use, communication technologies, and use environments.

Even in a case where it is necessary to change the combination or the selection rule during operation or to update the system, the user can cope with the change without changing the application, and the cost and the period required for the change can be reduced.

A communication device can be configured with a plurality of communication technologies through a general-purpose I/F without developing a communication device having a plurality of communication interfaces or a dedicated application to be executed by the communication device, and a selection rule thereof can be flexibly changed. Therefore, the application can be shared, and the development cost and the development period can be reduced.

### OTHER EXAMPLE EMBODIMENTS

A travel range of an auto-moving truck has expanded, and there may be a case where it is necessary to travel both indoors and outdoors. In that case, a wireless LAN may be used indoors, and a carrier network, not the carrier network N, may be used outdoors. In addition, in a case where a band is not required, a low power wide area (LPWA) may be used.

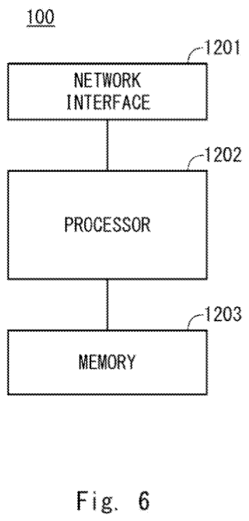

FIG. 6 is a block diagram illustrating an example of a hardware configuration of the communication device 100. Referring to FIG. 6, the communication device 100 includes a network interface 1201, a processor 1202, and a memory 1203. The network interface 1201 is used to communicate with other network node devices included in the communications system. The network interface 1201 may be used to perform wireless communications. For example, the network interface 1201 may be used to perform wireless LAN communication defined in IEEE 802.11 series or mobile communication defined in 3rd Generation Partnership Project (3GPP). Alternatively, the network interface 1201 may include, for example, a network interface card (NIC) conforming to IEEE 802.3 series.

The processor 1202 performs the processing in the communication device 100 described using the flowchart or sequence in the above-described example embodiment by executing software (a computer program) read from the memory 1203. The processor 1202 may be, for example a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage located away from the processor 1202. In this case, the processor 1202 may access the memory 1203 via an I/O interface (not illustrated).

In the example of FIG. 9, the memory 1203 is used to store a group of software modules. The processor 1202 can perform the processing in the communication device 100 described in the above-described example embodiment by executing the group of software modules read from the memory 1203.

As described with reference to FIG. 2 or 5, each of the processors included in the communication device 100 executes one or a plurality of programs including a group of commends for causing a computer to perform the algorithm described with reference to the drawings.

In the above-described example, the program can be stored using various types of non-transitory computer-readable media to be supplied to the computer. The non-transitory computer-readable media include various types of tangible storage media. Examples of the non-transitory computer-readable medium include a magnetic recording medium (e.g., a flexible disk, a magnetic tape, or a hard disk drive), an optical magnetic recording medium (e.g., a magneto-optical disk), a compact disc-read only memory (CD-ROM), a CD-R, a CD-R/W, and a semiconductor memory (e.g., a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable media include electric signals, optical signals, and electromagnetic waves. The transitory computer-readable media can supply the program to the computer via a wired communication path such as electric wires and optical fibers, or a wireless communication path.

Note that the present disclosure is not limited to the above-described example embodiments, and can be appropriately modified without departing from the gist.

Some or all of the above-described example embodiments may be described as in the following supplementary notes, but are not limited to the following supplementary notes.

(Supplementary Note 1)

A communication device including:
a plurality of wireless communication interfaces corresponding to a plurality of wireless communication technologies, respectively;
a characteristic acquisition and presentation unit that acquires information indicating wireless communication characteristics related to the communication device including the plurality of wireless communication interfaces and presents the information to a user;
a set information acquisition unit that acquires information set by the user with respect to the presented information indicating wireless communication characteristics related to the communication device;
a rule creation unit that interprets the information indicating wireless communication characteristics and the set information, and creates a selection rule for selecting one wireless communication technology from among the plurality of wireless communication technologies;
a situation grasping unit that grasps communication qualities according to the plurality of wireless communication interfaces; and
a selection unit that selects a wireless communication interface corresponding to a wireless communication technology to be prioritized among the plurality of wireless communication technologies on the basis of the selection rule and the communication qualities.

(Supplementary Note 2)

The communication device according to Supplementary Note 1, in which the set information includes at least one piece of information regarding communication use, communication performance, use environment, and operation of the communication device.

(Supplementary Note 3)

The communication device according to Supplementary Note 1 or 2, further including a selection rule description unit that describes the characteristics and the selection rule on the basis of a user input.

(Supplementary Note 4)

The communication device according to any one of Supplementary Notes 1 to 3, in which the plurality of wireless communication technologies include identical wireless communication technologies or different wireless communication technologies.

(Supplementary Note 5)

The communication device according to any one of Supplementary Notes 1 to 4, in which the characteristic acquisition and presentation unit abstracts the information indicating wireless communication characteristics related to the plurality of wireless communication interfaces, and presents the abstracted information to the user.

(Supplementary Note 6)

The communication device according to any one of Supplementary Notes 1 to 5, further including:
a wired communication interface for performing wired LAN communication with a device outside the communication device; and
a route switching unit that switches a route to connect the one wireless communication interface selected by the selection unit and the wired communication interface.

(Supplementary Note 7)

A communication system including:
a communication device; and
a mobile body on which the communication device is mounted,
in which the communication device includes:
a plurality of wireless communication interfaces corresponding to a plurality of wireless communication technologies, respectively;
a characteristic acquisition and presentation unit that acquires information indicating wireless communication characteristics related to the communication device including the plurality of wireless communication interfaces and presents the information to a user;
a set information acquisition unit that acquires information set by the user with respect to the presented information indicating wireless communication characteristics related to the communication device;
a rule creation unit that interprets the information indicating wireless communication characteristics and the set information, and creates a selection rule for selecting one wireless communication technology from among the plurality of wireless communication technologies;
a situation grasping unit that grasps communication qualities according to the plurality of wireless communication interfaces; and
a selection unit that selects a wireless communication interface corresponding to a wireless communication technology to be prioritized among the plurality of wireless communication technologies on the basis of the selection rule and the communication qualities.

(Supplementary Note 8)

The communication system according to Supplementary Note 7, further including:
a server that instructs a destination to the communication device mounted on the mobile body through wireless communication;
a first base station that wirelessly communicates with one of the wireless communication interfaces of the communication device; and
a second base station that wirelessly communicates with another one of the wireless communication interfaces of the communication device.

(Supplementary Note 9)

A communication method including:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.

(Supplementary Note 10)

A non-transitory computer-readable medium that stores a program, the program causing a computer to execute:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.

### REFERENCE SIGNS LIST

1 COMMUNICATION SYSTEM
10 COMMUNICATION DEVICE
11 SET INFORMATION ACQUISITION UNIT
12 CHARACTERISTIC ACQUISITION AND PRESENTATION UNIT
13 RULE CREATION UNIT
15 SELECTION UNIT
18 STATE GRASPING UNIT
19 WIRELESS COMMUNICATION INTERFACE
50 INPUT DEVICE
100 COMMUNICATION DEVICE
110 SET INFORMATION ACQUISITION UNIT
120 CHARACTERISTIC ACQUISITION AND PRESENTATION UNIT
130 RULE INTERPRETATION UNIT
140 RULE DESCRIPTION UNIT
150 SELECTION UNIT
160 WIRED COMMUNICATION INTERFACE
170 ROUTE SWITCHING UNIT
180 STATE GRASPING UNIT
190 WIRELESS COMMUNICATION INTERFACE
200 AP
300 L-RU
400 MOBILE BODY
500 SERVER

What is claimed is:

1. A communication device comprising:
a plurality of wireless communication interfaces corresponding to a plurality of wireless communication technologies, respectively;
at least one memory storing instructions, and
at least one processor configured to execute the instructions to;
acquire information indicating wireless communication characteristics related to the communication device including the plurality of wireless communication interfaces and present the information to a user;
acquire information set by the user with respect to the presented information indicating wireless communication characteristics related to the communication device;
interpret the information indicating wireless communication characteristics and the set information, and create a selection rule for selecting one wireless communication technology from among the plurality of wireless communication technologies;
grasp communication qualities according to the plurality of wireless communication interfaces; and
select a wireless communication interface corresponding to a wireless communication technology to be prioritized among the plurality of wireless communication technologies on the basis of the selection rule and the communication qualities.

2. The communication device according to claim 1, wherein the information set by the user includes at least one piece of information regarding communication use, communication performance, use environment, and operation of the communication device.

3. The communication device according to claim 1, wherein the at least one processor configured to execute the instructions to; describe or correct the characteristics and the selection rule on the basis of a user input.

4. The communication device according to claim 1, wherein the plurality of wireless communication technologies include identical wireless communication technologies or different wireless communication technologies.

5. The communication device according to claim 1, wherein the at least one processor configured to execute the instructions to; abstract the information indicating wireless communication characteristics related to the plurality of wireless communication interfaces, and presents the abstracted information to the user.

6. The communication device according to claim 1, further comprising:
a wired communication interface configured to perform wired LAN communication with a device outside the communication device; and
wherein the at least one processor configured to execute the instructions to; switch a route to connect the one wireless communication interface selected and the wired communication interface.

7-8. (canceled)

9. A communication method comprising:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.

10. A non-transitory computer-readable medium configured to store a program, the program causing a computer to execute:
acquiring information indicating wireless communication characteristics related to a communication device including a plurality of wireless communication interfaces and presenting the information to a user;
acquiring information set by the user with respect to the presented information indicating wireless communication characteristics related to the communication device;
interpreting the information indicating wireless communication characteristics and the set information, and creating a selection rule for selecting one wireless communication technology from among a plurality of wireless communication technologies;
grasping communication qualities according to the plurality of wireless communication interfaces; and
selecting a wireless communication interface corresponding to a wireless communication technology to be prioritized among the plurality of wireless communication technologies on the basis of the selection rule and the communication qualities.
